(19) United States
(12) Patent Application Publication
(10) Pub. No.: US 2024/0231473 A1
(43) Pub. Date: Jul. 11, 2024

(54) ADAPTIVE VOLTAGE SHUTDOWN DEMOTION

(71) Applicant: Intel Corporation, Santa Clara, CA (US)

(72) Inventors: Patrick Kam-shing Leung, Portland, OR (US); Akshay Parnami, San Bruno, CA (US); Jianwei Dai, Portland, OR (US); Saranya Sridaran Iyengar, Portland, OR (US); Michael F. Mallen, Portland, OR (US)

(21) Appl. No.: 18/069,269

(22) Filed: Dec. 21, 2022

(51) Int. Cl. G06F 1/3296; G06F 1/3287

(52) U.S. Cl. CPC G06F 1/3296; G06F 1/3287

(57) ABSTRACT

Embodiments described herein may include apparatus, systems, techniques, and/or processes that are directed to adaptively determining an optimum time frame or demotion threshold for when to power down a voltage rail of an idle device. The demotion threshold is typically the point where the energy cost for maintaining power to the device is approximately the same as or exceeds the energy cost of removing power to the device. The demotion threshold may vary with system conditions and may be based on device leakage current, wake voltage, capacitance, voltage regulator power consumption, current workload and the like. A power control unit in the computing system may manage the voltage of the device and determine the optimum demotion threshold. The power control unit may rely on physical inputs such as fuses on a motherboard, system inputs supplied by a manufacturer, current condition inputs and may be implemented in the device's or the system's software or firmware. By calculating the adaptive demotion threshold, power may be optimized based on platform-to-platform design variation and/or device part-to-part variation.

### TECHNICAL FIELD

Embodiments of the present disclosure generally relate to the field of computing, in particular, to power management of devices in a computing system during transition between active and idle states.

### BACKGROUND

The complexity of computing systems continues to increase at a fast pace. Today's computing systems may include in increasing number of devices, including devices with multiple processing units, input/output (I/O) devices, system on a chip (SoC) devices, multiple die packaged in a single device, and the like. The increasing number of devices consume an increasing amount of power.

Efforts to reduce power consumption may include powering down a device or a portion of a computing system during idle states. However, due to various system configurations, powering down/up a device entering/exiting an idle state may also consume a significant amount of power. When a device enters an idle state, the system may bring down a voltage rail to a device and upon exiting the idle state, the rail is brought back to an operational voltage level. Bringing the voltage back up to an operational level often causes a power spike due to an inrush of current which may be high enough to negate the power being saved by turning off the rail. Frequent cycling of entering and leaving an idle state while powering a device down may be counterproductive and consume more power than maintain power to the device.

A solution is needed that is dynamic, specific to system configuration, and reduces system power consumption and improving battery life and user experience.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a computing system in accordance with various embodiments.

FIG. 2 illustrates another computing system in accordance with various embodiments.

FIG. 3 illustrates a diagram of portions of a computing system in accordance with various embodiments.

FIG. 4 illustrates a power usage diagram in accordance with various embodiments.

FIG. 5 illustrates an energy tradeoff analysis in accordance with various embodiments.

FIG. 6 illustrates a flow diagram to determine an optimum demotion threshold in accordance with various embodiments.

### DETAILED DESCRIPTION

Embodiments described herein may include apparatus, systems, techniques, and/or processes that are directed to adaptively determining an optimum time frame or demotion threshold for when to power down a voltage rail of an idle device. The demotion threshold is typically the point where the energy cost for maintaining power to the device is approximately the same as or exceeds the energy cost of removing power to the device. The demotion threshold may vary with system conditions and may be based on device leakage current, wake voltage, capacitance, voltage regulator power consumption, current workload and the like. A power control unit in the computing system may manage the voltage of the device and determine the optimum demotion threshold. The power control unit may rely on physical inputs such as fuses on a motherboard, system inputs supplied by a manufacturer, current condition inputs and may be implemented in the device's or the system's software or firmware. By calculating the adaptive demotion threshold, power may be optimized based on platform-to-platform design variation and/or device part-to-part variation.

Customers may see better power efficiency across multiple workloads since the decision to turn the voltage rail off may be made based on the currently running workload. Also, customers may tune the behavior via system or device software.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

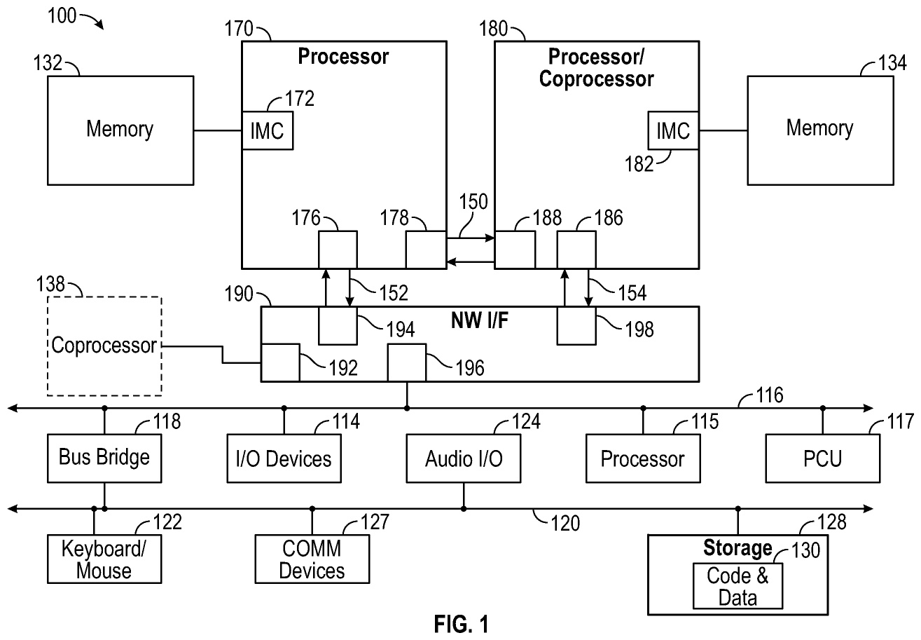

FIG. 1 illustrates a computing system in accordance with various embodiments. Multiprocessor system 100 is an interfaced system and includes a plurality of processors including a first processor 170 and a second processor 180 coupled via an interface 150 such as a point-to-point (P-P) interconnect, a fabric, and/or bus. In some examples, the first processor 170 and the second processor 180 are homogeneous. In some examples, first processor 170 and the second processor 180 are heterogenous. Though the example system 100 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 170 and 180 are shown including integrated memory controller (IMC) circuitry 172 and 182, respectively. Processor 170 also includes interface circuits 176 and 178, along with core sets. Similarly, second processor 180 includes interface circuits 186 and 188, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 170, 180 may exchange information via the interface 150 using interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a network interface (NW I/F) 190 via individual interfaces 152, 154 using interface circuits 176, 194, 186, 198. The network interface 190 (e.g., one or more of an interconnect, bus, and/or fabric, and in some examples is a chipset) may optionally exchange information with a coprocessor 138 via an interface circuit 192. In some examples, the coprocessor 138 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 170, 180 or outside of both processors, yet connected with the processors via an interface such as P-P interconnect, such that either or both processors' local cache information may be stored in the shared cache if a processor is placed into a low power mode.

Network interface 190 may be coupled to a first interface 116 via interface circuit 196. In some examples, first interface 116 may be an interface such as a Peripheral Component Interconnect (PCI) interconnect, a PCI Express interconnect, or another I/O interconnect. In some examples, first interface 116 is coupled to a power control unit (PCU) 117, which may include circuitry, software, and/or firmware to perform power management operations with regard to the processors 170, 180 and/or co-processor 138. PCU 117 provides control information to one or more voltage regulators (not shown) to cause the voltage regulator(s) to generate the appropriate regulated voltage(s). PCU 117 also provides control information to control the operating voltage generated. In various examples, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other examples, power management operations to be performed by PCU 117 may be implemented externally to a processor, such as by way of a separate power management integrated circuit (PMIC) or another component external to the processor. In yet other examples, power management operations to be performed by PCU 117 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 114 may be coupled to first interface 116, along with a bus bridge 118 which couples first interface 116 to a second interface 120. In some examples, one or more additional processor(s) 115, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 116. In some examples, second interface 120 may be a low pin count (LPC) interface. Various devices may be coupled to second interface 120 including. for example, a keyboard and/or mouse 122, communication devices 127 and storage circuitry 128. Storage circuitry 128 may be one or more non-transitory machine-readable storage media as described below, such as a disk drive or other mass storage device which may include instructions/code and data 130 in some examples. Further, an audio I/O 124 may be coupled to second interface 120. Note that other architectures than the point-to-point architecture described above are possible. For example, instead of the point-to-point architecture, a system such as multiprocessor system 100 may implement a multi-drop interface or other such architecture.

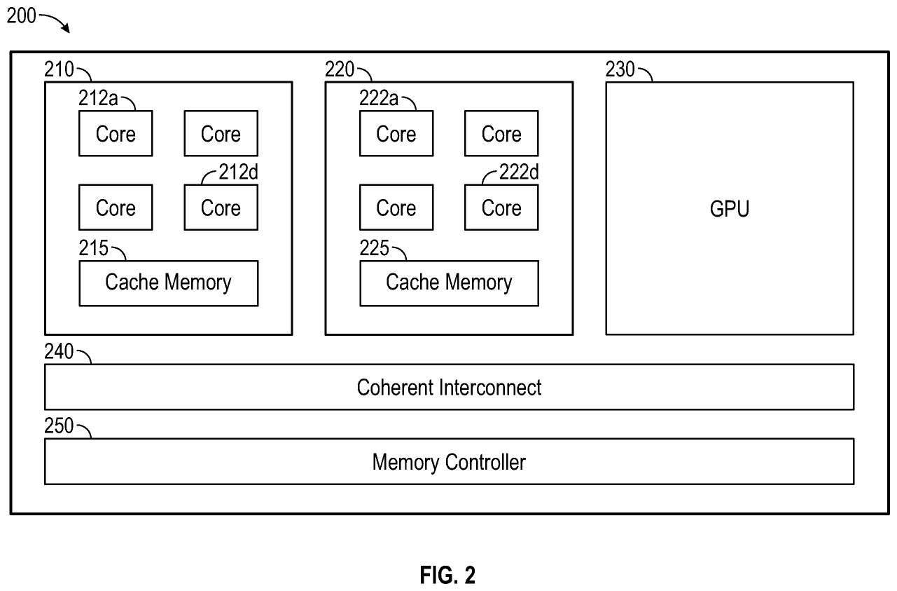

FIG. 2 illustrates another computing system in accordance with various embodiments. Computing system 200 may be any type of computing platform, ranging from small portable devices such as smartphones, tablet computers and so forth to larger devices such as client systems, for example, desktop or workstation systems, server systems and so forth.

As seen in FIG. 2, computing system 200 includes a first core domain 210 having a plurality of first cores 212a-212d. In an example, these cores may be low power cores such as in-order cores. In turn, these cores couple to a cache memory 215 of core domain 210. In addition, computing system 200 includes a second core domain 220. In the illustration of FIG. 2, second core domain 220 has a plurality of second cores 222a-222d. In an example, these cores may be higher power-consuming cores than first cores 212. In an embodiment, the second cores may be heterogeneous cores. In turn, these cores couple to a cache memory 225 of core domain 220. Note that while the example shown in FIG. 2 includes 4 cores in each domain, understand that more or fewer cores may be present in a given domain in other examples.

With further reference to FIG. 2, a graphics domain 230 also is provided, which may include one or more graphics processing units (GPUs) configured to independently execute graphics and other workloads, e.g., provided by one or more cores of core domains 210 and 220. As an example, GPU domain 230 may be used to provide display support for a variety of screen sizes, in addition to providing graphics and display rendering operations.

As seen, the various domains couple to a coherent interconnect 240, which in an embodiment may be a cache coherent interconnect fabric that in turn couples to an integrated memory controller 250. Coherent interconnect 240 may include a shared cache memory, such as an L3 cache, in some examples. In an embodiment, memory controller 250 may be a direct memory controller to provide for multiple channels of communication with an off-chip memory, such as multiple channels of a DRAM (not shown for case of illustration).

In different examples, the number of the core domains may vary. For example, for a low power SoC suitable for incorporation into a mobile computing device, a limited number of core domains such as shown in FIG. 2 may be present. Still further, in such low power SoCs, core domain 220 including higher power cores may have fewer numbers of such cores. For example, in one implementation two cores 222 may be provided to enable operation at reduced power consumption levels. In addition, the different core domains may also be coupled to an interrupt controller to enable dynamic swapping of workloads between the different domains.

In yet other embodiments, a greater number of core domains, as well as additional optional logic may be present, in that a computing system may be scaled to higher performance (and power) levels for incorporation into other computing devices, such as desktops, servers, high-performance computing systems, base stations and the like. As one such example, 4 core domains each having a given number of out-of-order cores may be provided. Still further, in addition to optional GPU support, one or more accelerators to provide optimized hardware support for particular functions (e.g. web serving, network processing, switching or so forth) also may be provided. In addition, an input/output interface may be present to couple such accelerators to off-chip components.

System 200 may include one or more power control units (not shown) to manage each domain, including adjusting voltage levels of various domains, as well as powering down one or more portions of system 200 during idle period in order to conserve power.

While a configuration of system 200 has been described, alternative embodiments may have different configurations. While system 200 is described as including the components illustrated in FIG. 2, alternative embodiments may include additional components that facilitate the operation of system 200.

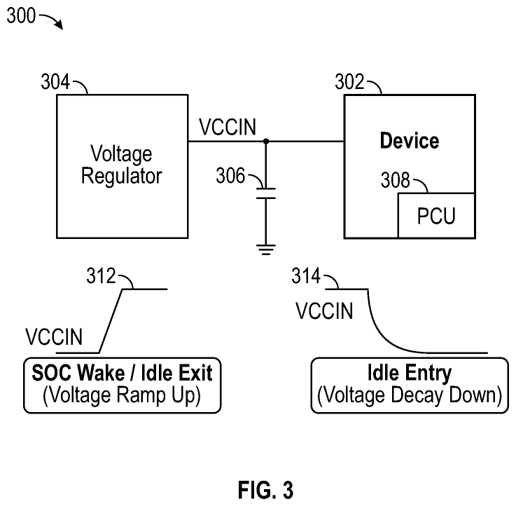

FIG. 3 illustrates a diagram of portions of a computing system 300 in accordance with various embodiments. A device 302 is coupled to a voltage regulator 304 with a dampening capacitor 306 coupled between device 302 and voltage regulator 304. Device 302 may be all or portions of a computing system such as computing system 100 or 200 and packaged and powered as a separate device by VCCIN from voltage regulator 304. According to some embodiments, capacitor 306 may be a physical capacitor or any other capacitance-like functionality. Voltage regulator 304 may provide dynamic voltage capability for device 302, for example, setting the operational voltage for 302 to different levels due to system conditions such as low battery charge, workload priority, current heat conditions of the system and the like.

As illustrated by voltage ramp-up curve VCCIN 312, upon power up or entering an active cycle of device 302, voltage regulator 304 will ramp up the voltage and energy will be put into capacitor 306 and bring device 302 to an operational voltage level. The ramp up voltage causes a large amount of inrush current. The amount of inrush current varies due to the amount of time in the idle cycle and if VCCIN has decayed to zero volts or still has remaining charge in capacitor 306.

Upon entering an idle state where device 302 is powered down, power control unit 308 may set voltage regulator 304 to voltage decay to zero voltage. The voltage on capacitor 306 gradually decays over time as illustrated by voltage decay down curve VCCIN 314.

During system run time, the active/idle cycle may be as frequent as every 1-16 milliseconds (ms) causing excessive energy consumption due to inrush current. As device 302 cycles between power states (one or more active and/or idle states) a significant amount of power may be consumed and it may be more cost efficient to keep device 302 powered up during an idle state. Further, device 302 may include a power control unit (PCU) 308 for managing the voltage level to device 302 as well as determining a demotion threshold for turning power off to device 302 during idle periods. A demotion threshold may be used to determine whether it is more energy efficient to keep device 302 powered up during an idle cycle or powered down during an idle cycle. Because the length of the idle cycle is not known ahead of time, the demotion threshold may be calculated based on current system conditions and recalculated when system conditions change. Such a calculation may have many input variables, some of which are defined by system configuration, for example, the size of capacitor 306 and the leakage current characteristics of device 302.

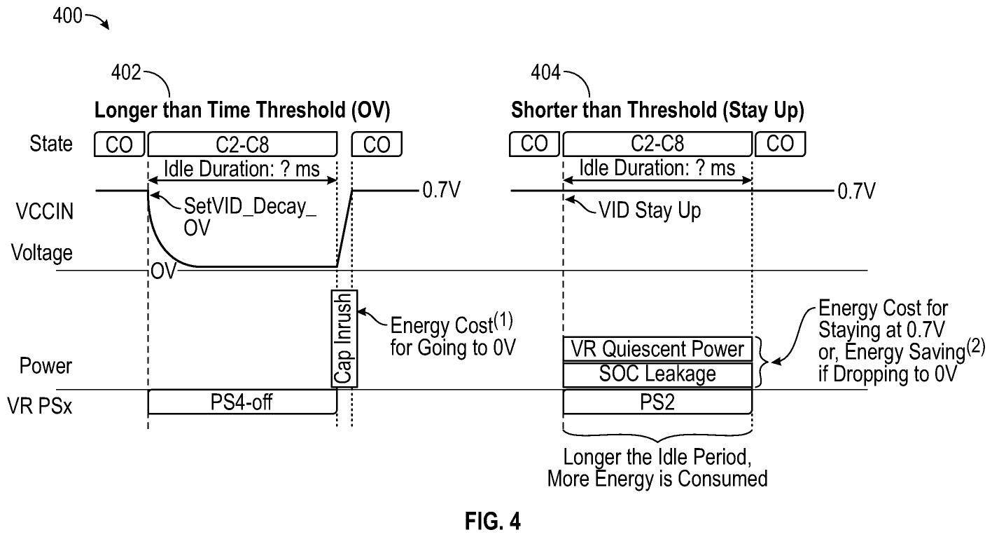

FIG. 4 illustrates power usage diagrams in accordance with various embodiments. Power usage diagrams 400 include a power usage diagram 402 where VCCIN voltage is set to decay to zero voltage as the device transitions from an active power state, for example, C0, to one or more of idle power states, for example, C2-C8, and a power usage diagram 404 where VCCIN voltage is kept at operational levels as the device transitions from the active power state C0 to one or more of the idle power states C2-C8. The amount of time in one or more of the idle power states C2-C8 is unknown, however, the idle cycles may be tracked over time and an estimated or expected idle time may be determined. According to various embodiments, a system may have any number of active power states, for example, when a device is powered to different operational voltage levels. According to various embodiments, a system may have any number of idle states, for example, when more or less functionality is powered or system down.

As shown, power usage diagram 402 illustrates power usage when a device, for example, device 302, is powered down during an idle cycle. VCCIN starts to decay as the device transitions from the active state C0, to an idle state, one or more of C2 to C8 and a voltage rail to the device is powered down. Most of the energy cost is due to capacitor inrush voltage upon the transition to the active state C0. If VCCIN has decayed to zero volts, the maximum amount of inrush current is needed to power the capacitor and bring the device's voltage to an operational level.

As shown, power usage diagram 404 illustrates power usage when the voltage regulator maintains power to the device during an idle cycle. VCCIN is maintained at the device's operational voltage level. Most of the energy cost is due to the voltage regulator's quiescent power and device leakage. As illustrated, the longer the idle period, the more energy is consumed.

A demotion threshold may be determined as the point in time when the energy cost for keeping the device powered exceeds the energy cost from capacitor inrush current. At this demotion threshold, it is more energy efficient to power down the device during an idle cycle.

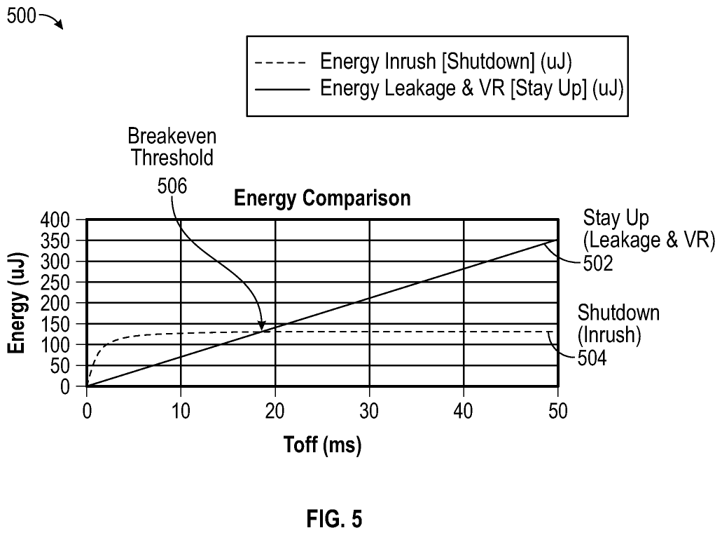

FIG. 5 illustrates an energy tradeoff analysis in accordance with various embodiments. Graph 500 illustrates the energy cost to keep the device powered up, curve 502, and the energy cost to power the device down during idle cycles, curve 504. As illustrated by curve 502, the energy cost to keep the device powered up is mostly linear over time and is mainly due to voltage regulator quiescent power and leakage current. As illustrated by curve 504, the energy cost to power the device down increases to a near steady state over time and is mainly due to the inrush current. Point 506 where curves 502 and 504 cross illustrates a breakeven threshold point (or a demotion threshold). Prior to the demotion threshold 506, it is more energy efficient to keep the device powered up during idle cycles. After the demotion threshold 506, it is more energy efficient to power down the device during idle cycles.

According to various embodiments, the decision to turn off the rail depends on multiple factors and multiple input parameters. These factors vary by the workload being run and by the manufacturer of the board. Because each system may be different, with different system configurations including different devices, capacitance, leakage current of connected devices and other circuitry, each system may have a different demotion threshold. Further, the demotion threshold may change over time due to system operation conditions and other factors.

According to some embodiments, as a device transitions into an idle state, the voltage rail is kept powered up until the demotion threshold timeframe has been exceeded and the device remains in an idle state. Once the demotion threshold timeframe has been exceeded, the voltage rail is powered down until the device leaves the idle state.

According to various embodiments, the calculations may include predicted time in the idle power state and the current workload of the computing system. For example, a power control unit may track the amount of time the device typically remains in an idle state. If the average time in an idle state exceeds the demotion threshold, the voltage rail is powered down upon entrance to the idle state. If the average time in an idle state is less than the demotion threshold, the voltage rail remains powered upon entrance to the idle state.

According to some embodiments, to determine the optimal demotion threshold, many variables/parameters may be used including device internal parameters, platform inputs, and platform internal parameters. Device internal parameters may be based on the device specification, which (optionally) may be adjusted part-to-part based on fuse reading set by the system manufacturer. Device internal parameters may include V_active (current voltage applied to the device) and device leakage. Platform inputs may be provided/programmed by the system or device manufacturer, and received by the power control unit, for example, from a BIOS mailbox. Platform inputs may be changed from design-to-design and may include voltage regulator quiescent power and size of capacitor (capacitance). Platform internal parameters may be based on the platform specification and may be characterized through validation. Platform internal parameters may include R_esr&board, slew rate, voltage regulator efficiency, capacitor leak constants a) and k0, MLCC ratio, and capacitor derate values −m and −b.

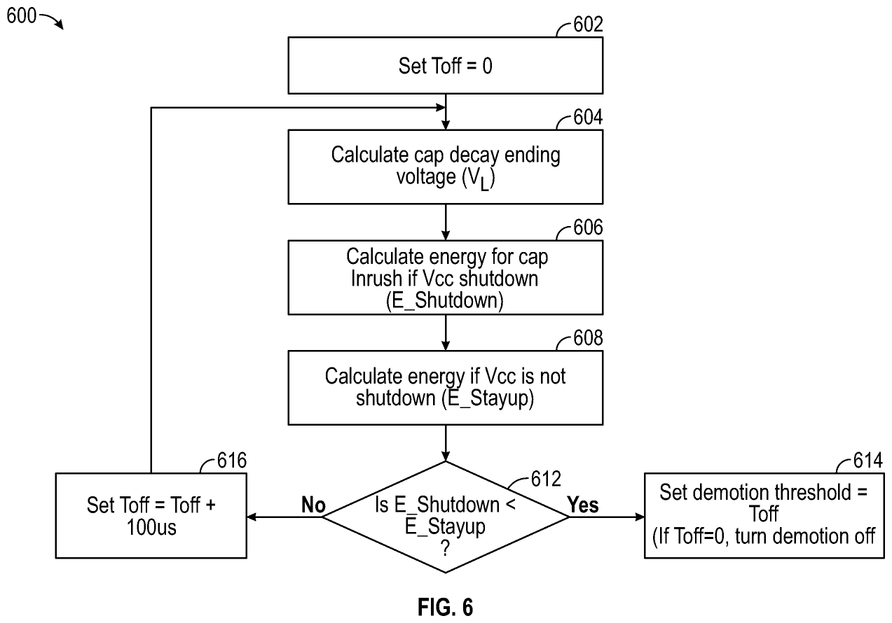

FIG. 6 illustrates a flow diagram to determine an optimum demotion threshold in accordance with various embodiments. Flow 600 begins calculating the demotion threshold by initially setting time (Toff) to zero, block 602. The capacitor decay ending voltage (VI.) is calculated for Toff, block 604. Capacitor decay ending voltage is the voltage level remaining on the dampening capacitor, for example, capacitor 306 at Toff. The energy (E_Shutdown) of capacitor inrush if voltage (Vcc) to the device is shutdown at Toff is calculated, block 606. The energy (E_Stayup) if the device remains powered up at Toff is calculated, block 608. A determination at block 612 is made whether energy cost of shutting down voltage to the device during idle cycles (E_Shutdown calculated in block 606) is less than the energy cost of the voltage level to the device (E_Stayup calculated in block 608). If the energy cost of shutting down is less than the energy cost of maintaining the voltage to the device, demotion threshold is set at Toff, block 614. If not, Toff is increased by an incremental amount, for example, 100 microseconds (us), block 616. The calculations in 604, 606 and 608 are repeated at the new Toff, until finding the optimal demotion threshold where E_shutdown is less than E_Stayup, block 614.

According to some embodiments, these calculations may be computed at early boot stage and/or during operation of the system when relevant system parameters change, for example, when the operating voltage of the device is changed, when idle cycle frequency and duration change, and other such factors.

Sample calculations for V_{L}, E_Shutdown and E_Stayup are shown below according to some embodiments. Alternate calculations may be performed using more or less variables but still provide reduced power consumption. Any values shown in these calculations are examples only since, differing device and system configurations require different calculations as each device and/or system may have different compositions, changing some or all of the input parameters.

### Calculating V_{L}—Capacitor Decay Energy Voltage

In order to calculate inrush power for the capacitor, the capacitor voltage at the end of the Toff period must be calculated first. As Toff increases, the capacitor voltage will continue to decay. When a device exits an idle state, the capacitor will be charged up from this low voltage point (V_{L}), also referred to as capacitor decay energy voltage, back to operational voltage (V_{H}.)

To model the capacitor decay voltage as Toff increase, the capacitor drain current (or device leakage) on Idle entry is characterized as this affects how fast and how much the voltage decays. The equation for capacitor leakage current is defined as:

$$I\_cap \_leak = a 0 * V cap \hat{} k 0$$

where a0 and k0 are constant that are found using test data.

To accurately model the capacitor voltage decay action, the calculations consider both the device leakage and the capacitor derating factor which varies by capacitor type (for example, bulk, multilayer ceramic, ceramic and the like) and voltage. With all these inputs, the capacitor voltage may be calculated in each Toff period. Some of the input parameters used may include:

C_platform—capacitance input parameter from platform

Vactive—the retention voltage if Vcc is to stay up or Vcc ramps back to on idle exit

MLCC_Ratio—C_MLCC/(C_MLCC+C_Bulk) (varies by product stock keeping unit (sku))

M-sku: 1.000

P-sku: 0.525

Cap_derate_m—Bulk Cap Derating factor-m: −0.4 (default) (varies based on capacitor type(s))

Cap_derate_b—Bulk Cap Derating factor-b: 0.13 (default) (varies based on capacitor type(s))

The capacitor decay energy calculation may begin with these initial conditions:

$$V cap [ 0 ] = V active$$

Icap[0]=a0*Vcap[0]\hat{ }k0 (where a0 and k0 may be defined by the device leakage consumption or the capacitor leakage output current)

$$Cap\_derating [ 0 ] = MAX ( MIN ( 0 , cap\_derate \_m * V cap [ 0 ] + cap\_derate \_m ) , - 0.85 )$$

$$C [ 0 ] = C\_platform * MLCC\_Ratio * ( 1 + Cap\_derating [ 0 ] ) + C\_platform * ( 1 - MLCC\_Ratio )$$

$$Toff [ 0 ] = 0$$

For each Toff time step, calculations may include:

$$C [ n ] = C\_platform * MLCC\_Ratio * ( 1 + Cap\_derating [ n ] ) + C\_platform * ( 1 - MLCC\_Ratio )$$

$$V cap [ n ] = V cap [ n - 1 ] - ( I cap [ n - 1 ] * ( T off [ n ] - T off [ n - 1 ] ) / C [ n ] )$$

Because the energy calculation for E_Shutdown in the next section uses these results, a lookup table of Vcap vs. Toff may be created saving repeated calculation steps.

### Calculating Energy (E_Shutdown) for Cap Inrush if Vcc Shutdown

Calculating the Energy for Capacitor Inrush if Vcc shutdown begins with these input parameters:

C=C[0] from V_{L} calculation—Capacitance of cap

R_esr&board—Sum of capacitance equivalent series resistance (ESR) and board resistance between inductor and capacitor

$$S R - D V I D Slew Rate ( dV / dt )$$

$$Eff < V R Efficiency$$

$$V active = V cap [ 0 ] - from {V}_{L} calculation$$

Vcap_lo[n]=VL @ Toff from last section—capacitor voltage after n ms of decay

The following equations may be used to calculate the energy for capacitor inrush, repeating the calculations for a range of Toffs, starting at zero us:

$$T\_ramp = ( V active - Vcap\_lo [ n ] ) / S R$$

$$I\_inrush = C * S R$$

$$P\_inrush \_pulse [ n ] = 0.5 * C * ( V active \hat{} 2 - Vcap\_lo [ n ] \hat{} 2 / T\_ramp + I\_inrush \hat{} 2 * R - esr \& board$$

$$E\_shutdown [ n ] @ Battery = P - inrush\_pulse [ n ] * T\_ramp / Eff$$

Note that as Toff changes (with, for example, 100 us increments), V_{L} of the capacitor from previous section will change, which then drives the change of T_ramp, P_inrush and E_shutdown.

### Calculating E_Stayup—Energy for Maintaining Vcc at Operational Values

To calculate E_stayup, the parameters and equations below may be used.

Pq—VR Pq (Quiescent Power) from BIOS mailbox

P_leakage—SOC Leakage Power at Vactive (assuming if staying up)

Eff—VR Efficiency

Using the following equations, the energy E_Stayup is calculated, repeating for small time steps, for example, Toff starting at zero us and incrementing, for example, in 100 us steps:

$$E\_stayup [ n ] = ( Pq + P\_leakage ) / Eff * T off [ n ]$$

According to some embodiments, original equipment manufacturers'/original device manufacturers' (OEM/ODM) customers may simply program a few platform parameters for the Vcc shutdown demotion calculation, saving them from using complex equations trying to figure out the optimal threshold to maximize power saving.

According to some embodiments, the demotion threshold may be determined by sku.

According to some embodiments, the demotion threshold may be tuned by each device unit or even dynamically adjusted during run time.

According to some embodiments, the device leakage parameters a0 and k0 may be characterized to scale based on fuse leakage fuse values on every unit. This will allow the threshold to be optimized on a per unit basis.

According to some embodiments, since the operating voltage of the device may change from workload to workload, optionally, the demotion threshold may be recalculated during run time when the operating voltage of the device changes.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

### EXAMPLES

The following examples pertain to further embodiments. An example may be a system, comprising a device; a voltage regulator coupled to the device to supply a voltage level to the device when the device is idle; and a power control unit to communicate to the voltage regulator the voltage level to supply to the device, the voltage level including a shutdown level and an operational level, the power control unit to determine the voltage level based on a demotion threshold; wherein the demotion threshold is a time at which a first energy cost is equal to a second energy cost, wherein the first energy cost is a first amount of energy for the voltage regulator to maintain the operational voltage level to the device and the second energy cost is a second amount of energy for the voltage regulator to change the voltage level to the shutdown level.

Another example may include wherein the power control unit further to set the voltage level to the operational voltage level when the first energy cost is less than the second energy cost.

Another example may include the power control unit further to determine the demotion threshold, wherein to determine the demotion threshold the power control unit to determine a capacitor decay voltage value over a time frame.

Another example may include wherein the capacitor decay voltage value over the time frame is to be stored in a look-up table.

Another example may include wherein to determine the demotion threshold the power control unit further to calculate the second energy cost using the capacitor decay voltage.

Another example may include wherein the power control unit to redetermine the demotion threshold if an operating voltage of the device is changed.

Another example may include wherein the power control unit further to compare the demotion threshold with an average idle cycle time, the power control unit to set the operational level to the device if the average idle cycle time is less than the demotion threshold.

Another example may include wherein the power control unit further to track idle cycle times while the device is in operation to determine the average idle cycle time.

Another example may include an apparatus comprising: a power control unit to communicate to a voltage regulator a voltage level to supply to a device, the voltage level including a shutdown level and an operational level, the voltage level based on a demotion threshold; wherein the demotion threshold is a time at which a first energy cost is equal to a second energy cost, wherein the first energy cost is a first amount of energy for the voltage regulator to supply the operational voltage level to the device and the second energy cost is a second amount of energy for the voltage regulator to supply the shutdown level to the device.

Another example may include wherein the power control unit further to set the voltage level to the operational voltage level when the first energy cost is less than the second energy cost.

Another example may include the power control unit further to determine the demotion threshold, wherein to determine the demotion threshold the power control unit to determine a capacitor decay voltage value over a time frame.

Another example may include wherein to determine the demotion threshold the power control unit further to calculate the second energy cost using the capacitor decay voltage.

Another example may include wherein the power control unit further to compare the demotion threshold with an average idle cycle time, the power control unit to set the operational level to the device if the average idle cycle time is less than the demotion threshold.

Another example may include wherein the power control unit further to track idle cycle times while the device is in operation to determine the average idle cycle time.

Another example may include a method comprising: communicating to a voltage regulator a voltage level to supply to a device when the device is idle, the voltage level including a shutdown level and an operational level, the voltage level based on a demotion threshold; wherein the demotion threshold is a time at which a first energy cost is equal to a second energy cost, wherein the first energy cost is a first amount of energy for the voltage regulator to supply the operational voltage level to the device and the second energy cost is a second amount of energy for the voltage regulator to supply the shutdown level to the device.

Another example may include setting the voltage level to the operational voltage level when the first energy cost is less than the second energy cost.

Another example may include determining a capacitor decay voltage value over a time frame.

Another example may include wherein the capacitor decay voltage value over the time frame is stored in a look-up table.

Another example may include wherein to determine the demotion threshold further comprising calculating the second energy cost using the capacitor decay voltage.

Another example may include comparing the demotion threshold with an average idle cycle time, and setting the operational level to the device at the beginning of an idle cycle if the average idle cycle time is less than the demotion threshold.

Another example may include an apparatus comprising means to perform one or more elements of a method described in or related to any of examples herein, or any other method or process described herein.

Another example may include one or more non-transitory computer-readable media comprising instructions to cause an electronic device, upon execution of the instructions by one or more processors of the electronic device, to perform one or more elements of a method described in or related to any of examples herein, or any other method or process described herein.

Another example may include an apparatus comprising logic, modules, or circuitry to perform one or more elements of a method described in or related to any of examples herein, or any other method or process described herein.

Another example may include a method, technique, or process as described in or related to any of examples herein, or portions or parts thereof.

Another example may include an apparatus comprising: one or more processors and one or more computer readable media comprising instructions that, when executed by the one or more processors, cause the one or more processors to perform the method, techniques, or process as described in or related to any of examples herein, or portions thereof.

Another example may include a signal as described in or related to any of examples herein, or portions or parts thereof.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or) more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A system comprising:
a device;
a voltage regulator coupled to the device to supply a voltage level to the device when the device is idle; and
a power control unit to communicate to the voltage regulator the voltage level to supply to the device, the voltage level including a shutdown level and an operational level, the power control unit to determine the voltage level based on a demotion threshold;
wherein the demotion threshold is a time at which a first energy cost is equal to a second energy cost, wherein the first energy cost is a first amount of energy for the voltage regulator to maintain the operational voltage level to the device and the second energy cost is a second amount of energy for the voltage regulator to change the voltage level to the shutdown level.

2. The system of claim 1, wherein the power control unit further to set the voltage level to the operational voltage level when the first energy cost is less than the second energy cost.

3. The system of claim 1, the power control unit further to determine the demotion threshold, wherein to determine the demotion threshold the power control unit to determine a capacitor decay voltage value over a time frame.

4. The system of claim 3, wherein the capacitor decay voltage value over the time frame is to be stored in a look-up table.

5. The system of claim 3, wherein to determine the demotion threshold the power control unit further to calculate the second energy cost using the capacitor decay voltage.

6. The system of claim 3, wherein the power control unit to redetermine the demotion threshold if an operating voltage of the device is changed.

7. The system of claim 1, wherein the power control unit further to compare the demotion threshold with an average idle cycle time, the power control unit to set the operational level to the device if the average idle cycle time is less than the demotion threshold.

8. The system of claim 7, wherein the power control unit further to track idle cycle times while the device is in operation to determine the average idle cycle time.

9. An apparatus comprising:
a power control unit to communicate to a voltage regulator a voltage level to supply to a device, the voltage level including a shutdown level and an operational level, the voltage level based on a demotion threshold;
wherein the demotion threshold is a time at which a first energy cost is equal to a second energy cost, wherein the first energy cost is a first amount of energy for the voltage regulator to supply the operational voltage level to the device and the second energy cost is a second amount of energy for the voltage regulator to supply the shutdown level to the device.

10. The apparatus of claim 9, wherein the power control unit further to set the voltage level to the operational voltage level when the first energy cost is less than the second energy cost.

11. The apparatus of claim 9, the power control unit further to determine the demotion threshold, wherein to determine the demotion threshold the power control unit to determine a capacitor decay voltage value over a time frame.

12. The apparatus of claim 11, wherein to determine the demotion threshold the power control unit further to calculate the second energy cost using the capacitor decay voltage.

13. The apparatus of claim 9, wherein the power control unit further to compare the demotion threshold with an average idle cycle time, the power control unit to set the operational level to the device if the average idle cycle time is less than the demotion threshold.

14. The apparatus of claim 13, wherein the power control unit further to track idle cycle times while the device is in operation to determine the average idle cycle time.

15. A method comprising:
communicating to a voltage regulator a voltage level to supply to a device when the device is idle, the voltage level including a shutdown level and an operational level, the voltage level based on a demotion threshold;
wherein the demotion threshold is a time at which a first energy cost is equal to a second energy cost, wherein the first energy cost is a first amount of energy for the voltage regulator to supply the operational voltage level to the device and the second energy cost is a second amount of energy for the voltage regulator to supply the shutdown level to the device.

16. The method of claim 15, further comprising setting the voltage level to the operational voltage level when the first energy cost is less than the second energy cost.

17. The method of claim 15, further comprising determining a capacitor decay voltage value over a time frame.

18. The method of claim 17, further comprising storing the capacitor decay voltage value over the time frame in a look-up table.

19. The method of claim 17, wherein to determine the demotion threshold further comprising calculating the second energy cost using the capacitor decay voltage.

20. The method of claim 15, further comprising comparing the demotion threshold with an average idle cycle time, and setting the operational level to the device at the beginning of an idle cycle if the average idle cycle time is less than the demotion threshold.
